(19) United States
(12) Patent Application Publication
(10) Pub. No.: US 2025/0250033 A1
(43) Pub. Date: Aug. 7, 2025

(54) Thermomodulating Heat Pipe

(71) Applicant: Government of the United States as represented by the Secretary of the Air Force, Wright-Patterson AFB, OH (US)

(72) Inventor: Jonathan Allison, Albuquerque, NM (US)

(21) Appl. No.: 19/184,358

(22) Filed: Apr. 21, 2025

Related U.S. Application Data
(63) Continuation-in-part of application No. 17/824,893, filed on May 25, 2022.
(60) Provisional application No. 63/192,763, filed on May 25, 2021.

(51) Int. Cl. B64G 1/50; F28D 15/04

(52) U.S. Cl. CPC B64G 1/506; F28D 15/04

(57) ABSTRACT

A thermomodulating heat pipe is provided including a heat pipe envelope having a capillary wick extending substantially continuously the full length of the heat pipe and a void space interior of the capillary wick. The heat pipe envelope has a nominal evaporator section, a nominal condenser section where the nominal condenser section includes an active condenser portion and an inactive condenser portion, and a reservoir section extending from the inactive condenser portion. At a nominal condition, a heat pipe fluid is provided with a liquid phase filling the capillary wick and a vapor phase filling the void space of the nominal evaporator section and the active condenser portion, a non-condensable gas filling the void space of at least the reservoir section and the inactive condenser portion. Depending on thermal conditions, both prograde and retrograde heat transfer are enabled.

### CROSS-REFERENCE TO RELATED APPLICATIONS

This application is a continuation-in-part of U.S. application Ser. No. 17/824,893, entitled “Thermomodulating Heat Pipe,” filed on May 25, 2022, which claims the benefit of and priority to U.S. Provisional Application Ser. No. 63/192,763, entitled “Thermomodulating Heat Pipe,” filed on May 25, 2021, the entireties of which are incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

Field of the Invention. The present invention relates generally to the field of thermal control, and more specifically to the fields of thermomodulating heat pipes capable of providing variable conductance and diode functions for enhanced spacecraft thermal management.

### DESCRIPTION OF THE RELATED ART

Spacecraft require thermal control or regulation to address several issues, including Heat Acquisition, Heat Collection, Heat Transport, Heat Rejection, Heat Provision (storage), Heat Insulation, and thus in context, Heat Regulation. Heat Acquisition, Collection, Transport, and Rejection focus on taking uncontrolled thermal dissipation (generated heat) from its point of generation to the ultimate space sink. Heat Provision provides time-phasing to deal with thermal transients. Heat Insulation keeps environmental heat loads from overwhelming the thermal control system, and lastly, Heat Regulation permits the thermal control system to adjust its thermal connection to the environment to solve issues such as excessive heat loss in cold environments or excessive environmental heat absorption in hot environments. Heat Regulation can be seen as a capability to combine the tasks of Heat Insulation and Heat Rejection as needed throughout the mission. The Heat Regulation task may be characterized by its level of required temperature precision: many payloads are satisfied enough to stay within a 50 C operational band, while some sensitive science instruments require sub-millikelvin precision. Most development efforts heretofore have focused on providing Heat Regulation to very needy payloads requiring high precision and have neglected simpler solutions to simpler, coarser challenges.

There are a variety of insufficient existing solutions to the task of Heat Regulation. The first, and default solution, may be said to be a ‘cold biased’ radiator+heaters+batteries+feedback control. ‘Cold biased’ is an awkward way of saying that the design is intended to provide a cool-enough temperature in the hot environment and that heater power with feedback control maintains a satisfactory temperature on the thermal radiator. This is the most common form of Heat Regulation and is applied on most thermal radiators on practically every spacecraft. However, this solution provides no hot-side protection and sometimes requires excessive heater power which is usually the stimulus to consider alternatives.

A second solution, Thermal Capacitors, which includes both simple thermal masses (often Beryllium blocks) and phase change materials (PCMs) which use their heat of fusion to provide/store heat over melt/freeze cycles. Thermal Capacitors can be used to provide either hot-side or cold-side protection. These tend to be too heavy for all but small/local applications.

Thermal switches are a third solution. Thermal switches carry a penalty of excessive thickness in the thermal stackup as well as tending to be too heavy for widespread application. They also have moving parts which makes them unreliable. Thermal switches are only suited for local, niche applications and have not had much acceptance in recent decades.

Louvers are a known, but somewhat uncommon solution that tends to be used on outer solar system probes and some earth orbiting spacecraft of the 1980's. Louvers tend to be heavy and their moving parts make them unreliable. However, they've seen a small recent resurgence due to their ability to adjust the effective emissivity of the thermal radiators, thereby providing Heat Regulation to the entire thermal stackup.

Deployable or actuatable blankets may be used to cover thermal radiators during cold environments. Deployable blankets are used fairly commonly to provide insulation while spacecraft and their solar arrays are stowed and there is insufficient electrical power to heat any exposed radiators. Stowed solar arrays typically cover most of a spacecraft's thermal radiators and act as deployable blankets in this sense. Deployable blankets are only useful to provide Heat Regulation as a single on-to-off transition. Actuatable blankets have been proposed that could provide frequent and repeated transitions between ‘on’ and ‘off’ states, however these would come with some considerable mechanism risk that would require considerable development effort to manage. Additionally, actuatable blankets cause spacecraft dynamics challenges that would need to be addressed.

Variable Emissivity Materials (VEMs) provide the prospect of a radiator thermo-optical coating that can change emissivity in response to temperature or electrical inputs. VEMs offer the value of louvers (Heat Regulation of the entire thermal stackup) without the moving parts (unreliability, mass). VEMs are under development but are still an immature technology as the challenges of achieving complicated active materials in the formidable space environment still must be overcome.

Pumped Fluid Loops (PFLs) with bypass lines and thermostatic valves are a fifth solution. This is quite a popular Heat Regulation solution for both human and robotic missions. However, PFLs have reliability issues. One analysis found that PFLs have a 14% failure rate; failures ranged from mission degradation to requiring major replacements. NASA's robotic mission experience with such PFLs has been much more reliable than human spaceflight (MER Opportunity famously exceeded its design life by 55×), which is attributed to their less complicated design than PFLs for human spaceflight. PFL unreliability causes tend to be related to unexpected/undesigned-for debris contamination (and thermostatic valves are complicit with the debris in this type of problem) or issues with pump package design. PFLs are not recommend because they are heavy, expensive, complicated, long lead, and the serial spacecraft assembly time. There are better alternatives, including various heat pipe systems that use a heat pipe fluid which can flow as a liquid through a capillary wick, evaporate when accepting heat to form a vapor and condenses to liquid when rejecting heat.

Loop Heat Pipes (LHP) with heater feedback control of the compensation chamber (CC) enable precise Heat Regulation over limited environments. Environmental range capabilities can be extended via dedicated thermal radiators for the CC and/or using thermoelectric coolers (TEC) on the CC to permit the LHP to operate at a lower operating temperature than it would otherwise tend to. This approach is cheaper and more reliable than PFLs but care must be taken with the design of an LHP's thermodynamics and novel LHP designs pose some risk in this area.

A Dual Condenser LHP (DCLHP) with condensers mounted on opposite faces of the spacecraft where either face can see high sun angles, as high as normal sun angles, has been developed. In such a situation, the DCLHP passively shuts down fluid flow to/from whichever radiator is in the sun and then preferentially directs it to the cooler radiator. DCLHPs offer good prospects but, as LHPs, they are still expensive compared to other heat pipes. Also, the DCLHP has challenging integration aspects that make them less attractive to spacecraft integration engineers.

A Variable Conductance Heat Pipe (VCHP) can provide cold-side heat regulation. A VCHP is like a conventional Constant Conductance Heat Pipe (CCHP) having an evaporator and a condenser containing the heat pipe fluid in liquid form at least in the capillary wick and vapor filling the interior volume not occupied by liquid, with the VCHP additionally having an additional charge of a non-condensable gas (NCG) filling at least a gas reservoir (not present in a CCHP) and a portion of the pipe. A typical VCHP 10 is illustrated in FIGS. 1A and 1C with a heat pipe envelope 11, typically an extrusion including a pipe wall 12 as depicted in cross-section view FIG. 1B for one embodiment with an extruded bore 14 forming a wick 16 and a vapor space 18. While the cross-section view shown in FIG. 1B is an extruded bore with rectangular grooves 19, heat pipes using a capillary wick can have many embodiments. FIG. 1D illustrates a sintered metal wick heat pipe envelope 40 with a sintered metal wick 41 enabling the wick 16 capillary flow. FIG. 1E illustrates a screen wick heat pipe envelope 42 with a screen wick 43 enabling the wick 16 capillary flow. Other extruded groove wick configurations such as a trapezoidal groove wick heat pipe envelope 44 with trapezoidal grooves 45 and an arterial groove wick heat pipe envelope 46 with arterial (also referred to as omega) grooves 47 are illustrated in FIGS. 1F and 1G respectively. The wick 16 transports a heat pipe fluid in liquid phase from a condenser section 20 through an adiabatic section 22 to an evaporator section 24 by capillary action within the wick 16. More particularly, in operation the heat pipe fluid liquid 30 evaporates into a vapor phase as it receives heat in the evaporator section 24, with the wick 16 drawing heat pipe fluid liquid 30 into the evaporator section 24 to continuously replace the evaporant. The evaporant heat pipe fluid vapor 32 fills the vapor space 18 within the heat pipe envelope 11 and condenses to liquid phase, coalescing into the wick 16 in the condenser section 20, enabling the cycle with heat received 28 into the evaporator section 24 and heat rejected 26 from the condenser section 20. While this cycle described above applies to both a CCHP and a VCHP, the condenser of a VCHP extends to a gas reservoir, such as a gas reservoir bottle 34 holding NCG 36 with an initial charge pressure such that a diffuse front 38 exists between the NCG and the heat pipe fluid vapor. As shown in FIG. 1A, the condenser is fully active. In cold environments, when the heat pipe fluid's vapor pressure decreases with more condensation of the heat pipe fluid in the condenser, the NCG 36 pressure (governed, to first order, by the ideal gas law) decreases, but not as rapidly as the heat pipe fluid vapor 32. This causes the NCG 36 to grow into the space of the condenser as depicted in FIG. 1C showing an inactive condenser portion 21, and can be used to partially or fully block the condenser and provide large turndown ratios in cold environments wherein an active condenser portion 23 has heat rejected 26. VCHPs can be made in many types, the most common forms are uncontrolled VCHPs with wicked cold reservoirs, heater feedback controlled VCHPs with wicked cold reservoirs, and heater feedback controlled VCHPs with unwicked hot reservoirs. The former described VCHP types are simpler (i.e. cheaper and more reliable) but have less control authority whereas the latter described types are more complicated (i.e. more expensive, more development risk) and have greater control authority. In general, larger reservoirs enable greater control authority but even infinitely large reservoirs can only provide a finite degree of control authority. Most VCHPs in use today are used for rather tight temperature control situations to provide passive thermal control to temperature sensitive payloads. VCHPs cannot provide hot-side Heat Regulation.

A Diode heat pipe (DHP) can provide hot-side Heat Regulation. Several types of DHPs exist, two common types are liquid trap DHPs (LTD HP) and gas reservoir DHPs (GRDHP). LTDHPs have a liquid trap attached to the end of the evaporator that can contain the entire fluid inventory of the heat pipe. If heat flow goes from a nominal condenser to a nominal evaporator (the nominal condition for each being the “designed for” function) then the liquid tends to all collect in the liquid trap where it cannot proceed back into the rest of the heat pipe, thus ‘burning out the heat pipe’ and preventing any further retrograde heat transfer. When heat flow in the prograde (“designed for”) direction resumes, the liquid in the liquid trap evaporates, moves to the nominal condenser, condenses, and regular heat pipe operation resumes. GRDHPs function by having a gas reservoir similar to VCHPs where the gas reservoir contains enough gas that if retrograde heat transfer occurs, the gas will be swept to the nominal evaporator where it blocks the nominal evaporator and prevents retrograde heat transfer (or to be specific, dramatically reduces it by forcing condensation to happen in the nominal adiabatic section and then the heat must conduct through the heat pipe wall, which acts as a choke). DHPs are quite rarely used, all known flight experiments and spacecraft applications of DHPs have been LTDHPs. DHPs cannot provide cold-side Heat Regulation.

Since VCHPs and DHPs provide complementary functions, it would make sense to pair these technologies to achieve full-spectrum Heat Regulation, such as was done on the Clementine lunar space probe.

Thus, 11 different existing technologies to achieve Heat Regulation have been presented alongside their disadvantages. When considering the array of technologies available to the field of spacecraft thermal control, it is clear that some of the tasks of spacecraft thermal control are better served by existing technologies than others. The task of Heat Regulation is particularly poorly served by existing technologies due to its difficult nature: Heat Regulation is a Goldilocks problem: (‘This porridge is too hot; this porridge is too cold!’) which creates a surprising number of additional performance metrics and challenges beyond that experienced by simpler thermal tasks such as Heat Rejection and Heat Insulation where performance is not measured in terms of precision but in terms of magnitude.

The terms ‘payload’ and ‘bus’ are terms used in spacecraft design which can mean different things in different circumstances. However, in general, the ‘payload’ is the thing that the customer wants to accomplish their mission and the ‘bus’ is anything that is needed in order to support the payload. The definitional ambiguity arises in that ‘the customer’ depends on whom the speaker is. For the purpose of this discussion, the ‘payload’ performs the mission and needs ‘personalized’ thermal control, such as a sensor or electronic equipment. Many sensors require tighter thermal control precision than other parts of the spacecraft and have dedicated Heat Regulation components to accomplish this purpose. For the purpose of this discussion, the ‘bus’ is a heat pipe network that gathers, agglomerates, and transports heat from a variety of less picky (temperature precision-wise) electronics units and distributes this heat to thermal radiators.

In addition to the natural challenge of the Heat Regulation task, designers of Heat Regulation technology have historically placed an excessive priority on solving the needs of high precision payloads rather than low precision buses. VCHPs are currently used for payload applications, not bus applications. Payload applications typically require high temperature precision (<3 C variation) whereas bus applications could accept a much looser temperature precision (e.g. 20 to 60 C). As mentioned earlier, cost and development risk are incurred with tighter temperature precision. Thus, spacecraft prime integrators have not broadly accepted VCHPs for bus applications because of their expense, and have only been offered by heat pipe manufacturers for payload applications. Nonetheless, there are great opportunities for spacecraft size, mass, power, cost, and reliability improvements if bus application VCHPs were used. The missed opportunities are literally visible on the blanketed (i.e. thermally useless) faces of spacecraft.

Accordingly, there is a need in the art for a new solution that can provide simple, reliable, cheap, light, small, passive, Heat Regulation for bus applications. Specific bus applications will be described.

### SUMMARY OF THE INVENTION

The present invention overcomes the foregoing problems and other shortcomings, drawbacks, and challenges of existing thermal control and heat regulation apparatus and methods. While the invention will be described in connection with certain embodiments, it will be understood that the invention is not limited to these embodiments. To the contrary, this invention includes all alternatives, modifications, and equivalents as may be included within the spirit and scope of the present invention.

A heat pipe is provided that is a thermomodulating heat pipe (TMHP) having, in one embodiment, a heat pipe envelope suitable for use as a CCHP with a capillary wick extending substantially continuously the full length of the heat pipe and with a vapor space interior of the capillary wick. The heat pipe includes a nominal evaporator section, a nominal condenser section, and a reservoir section (the reservoir section not included in a CCHP). The term “nominal” indicates the designed for thermophysical behavior of that section under prograde heat flow, i.e. the object-to-be-cooled is warmer than the environmental sink temperature. The nominal evaporator receives heat through the heat pipe envelope and uses it to evaporate liquid in the wick. An optional adiabatic section may be intermediate the nominal evaporator section and the nominal condenser section, where heat neither enters nor leaves the TMHP, thus in normal operation fluid travels through the adiabatic section without changing phase. The nominal condenser is designed to connect to a heat sink such that heat pipe fluid vapor condenses, is collected by the wick and is transported back through the wick to the nominal evaporator by capillary tension. All of the operation of the heat pipe with respect to an evaporator section and a condenser section is identical to a CCHP. The TMHP however, has additional features and capabilities. The nominal condenser is subdivided into two subsections: an active condenser portion and an inactive condenser portion. The active condenser portion is where condensation is taking place, the inactive condenser portion vapor space is blocked by NCG that has grown out from its location in the reservoir section. The inactive section consumes more of the overall nominal condenser section at cold operating temperatures and less at high operating temperatures. At an initial, nominal condition, the NCG forms a diffuse front with the heat pipe fluid vapor. While typical existing VCHPs use bottles of larger diameter than the heat pipe envelope to achieve large reservoir volume to condenser volume ratios which gives high levels of control needed in current applications, such a large reservoir is not necessary to solve bus application Heat Regulation tasks, as earlier described. The TMHP can use the exact same heat pipe envelope, such as an extrusion, unmodified, to serve as the reservoir section. This permits the simplest possible manufacturing approach. In operation, if conditions cause heat flow into the nominal condenser section and heat flow out of the nominal evaporator section, retrograde heat transfer occurs, diffusion of the NCG with the vapor phase of the heat pipe fluid increases and the NCG can ultimately all move to the nominal evaporator section. When conditions return to the nominal heat flow into the nominal evaporator section and heat flow out from the nominal condenser section, this subsequent prograde heat transfer will likewise cause diffusion of the gases such that the NCG will return to the reservoir section.

The heat pipe envelope can be formed from any suitable material, including aluminum, stainless steel, and brass alloys. The heat pipe envelope can be an extruded bore. The heat pipe fluid can be any fluid compatible with the envelope material, which may be ammonia or methanol where appropriate. For example, CRES316 or brass can be used with methanol for some embodiments as the fluid, and aluminum can be used with ammonia as the fluid.

In one embodiment, the reservoir section has a length between your 0.75 to 10 times the length of the nominal condenser section. In another embodiment, the reservoir section has a length between your 0.75 to 3 times the length of the nominal condenser section. The nominal condenser section can have a length sized to accommodate a liquid slug length.

In one embodiment, the reservoir section can be thermally coupled to a warm spacecraft cavity, and in another embodiment the reservoir section can be thermally coupled to a cold spacecraft radiator.

Embodiments of the TMHP can use capillary wicks of types including a grooved wick, a screen wick, or a sintered metal wick. Types of grooved wicks include using rectangular grooves, trapezoidal grooves, and arterial wick grooves.

In one embodiment a spacecraft system for heat regulation uses a TMHP adapted to transport heat between a payload and a radiator. The TMHP can include at least one strain relief bend between the nominal evaporator section and a nominal condenser section. A TMHP can be installed to transport heat through a separate heat pipe to a radiator. A TMHP can also be installed to receive heat from a payload through a separate heat pipe.

Multiple TMHP's can be used in combination. In one embodiment a reservoir section from a first TMHP is thermally coupled to the nominal evaporator section of a second TMHP. The nominal condenser of the second TMHP can be thermally coupled to the thermal radiator of the first TMHP.

A TMHP reservoir section can include at least one temperature sensor to provide feedback control enabling controlling the temperature of the reservoir, where the temperature can be modified by heaters, cold-biased radiators, and/or thermoelectric coolers.

A spacecraft designed for geosynchronous orbit can have a TMHP installed on at least one of the East and West facing sides.

A Thermomodulating Heat Pipe (TMHP) provides a better solution to the task of Heat Regulation, one of the tasks that must be accomplished in spacecraft thermal control. TMHP enables a spacecraft to increase or decrease thermal conductance from the payload requiring thermal management and to do this in space thermal environments that are both colder and hotter than the operating temperature range of the payload. All of this can be accomplished passively, i.e. without moving parts, heaters, feedback control, or computers. This keeps TMHP reliability high as well as keeping cost low. Additionally, TMHP eschews heat pipe design features that drive cost and/or cause reliability risks such as screen wicks and bottles.

TMHP prevents heat flow into the TMHP's payload when the thermal environment is hotter than the payload. This situation can occur in situations with space probes going to the inner solar system or to planetary bodies without an atmosphere that have very high surface temperatures at the subsolar point (e.g. the moon). In this situation, diode heat pipes (DHPs) may be used. This situation can also occur on spacecraft irrespective of planetary bodies wherein a face of the spacecraft periodically receives normal or near normal solar illumination. In this latter case, the typical solution is to write-off that surface of the spacecraft for use as thermal radiator and instead pursue only more benign faces for thermal radiators, which represents a serious lost opportunity. In such situations where the normal or near normal solar illumination can be restricted to short duration, thermal radiators can be used on such faces alongside pointing duration restrictions that affect mission availability.

Secondly, TMHP prevents excessive heat flow out of the TMHP's payload when the thermal environment is cold enough that the payload would tend to get too cold and, in typical designs, require heater power. Frequently, 1) early-stage designs, 2) designs with very large/thin spacecraft, and 3) space probe missions with a large variation in solar distance experience difficulty providing sufficient heater power to the heaters. This pushes designers to a ‘Heat Regulation’ technology, all existing versions of which have undesirable features.

The TMHP provides both hot- and cold-side Heat Regulation with a simple, passive (i.e. reliable and cheap) design that takes advantage of the market's missed opportunity to provide low precision Heat Regulation for spacecraft bus applications.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1A is a plan view schematically illustrating a variable conductance heat pipe (VCHP) operational with the NCG in the gas reservoir;

FIG. 1B is a sectional view taken along section line 1B-1B of FIG. 1A showing a heat envelope cross section;

FIG. 1C is the plan view schematically illustrating a VCHP with the NCG blocking a portion of the condenser;

FIG. 1D is a cross section showing a sintered metal wick;

FIG. 1E is a cross section showing a screen wick;

FIG. 1F is a cross section showing a trapezoidal groove wick;

FIG. 1G is a cross section showing an arterial groove wick;

FIG. 2A is a plan view schematically illustrating a TMHP with relative section lengths in prograde heat transfer;

FIG. 2B is a plan view schematically illustrating the TMHP of FIG. 2A with variable heat transfer;

FIG. 2C and FIG. 2D are plan views schematically illustrating the TMHP of FIG. 2A that would be inoperable due to heat flow splitting the NCG bubble;

FIG. 3A is a plan view schematically illustrating a TMHP in prograde heat transfer, high temperature;

FIG. 3B is plan view schematically illustrating a TMHP in prograde heat transfer with the nominal condenser partially blocked by the NCG;

FIG. 3C is plan view schematically illustrating a TMHP in retrograde heat transfer, high temperature, with the NCG blocking the nominal evaporator section;

FIG. 3D is a plan view schematically illustrating a TMHP in retrograde heat transfer, low temperature, with the NCG blocking the nominal evaporator and a portion of the nominal condenser;

FIG. 4 is a schematic depiction of a satellite using ‘TMHP's;

FIG. 5 is a schematic depiction of a satellite with deployable radiator panels and using ‘TMHP's;

FIG. 6 is a schematic depiction of a satellite using ‘TMHP's to enable pointing to targets other than nadir;

FIG. 7A is a schematic depiction of a TMHP embedded in a radiator with heat radiated to space;

FIG. 7B is a schematic depiction of a TMHP embedded in a radiator with heat conducted to other heat pipes;

FIG. 8 is a schematic depiction of ‘TMHP's modulating heat transfer to radiators facing opposite directions;

FIG. 9 is an illustration of a proliferated LEO constellation satellite;

FIG. 10 is a schematic depiction of a satellite having a zenith radiator enabled by ‘TMHP's;

FIG. 11 provides a flowchart of a heat pipe envelope manufacturing process for one embodiment of a TMHP,

FIG. 12 provides a flowchart of a fill process for one embodiment of a TMHP; and

FIG. 13 provide a flowchart generally describing test and operation of one embodiment of a TMHP;

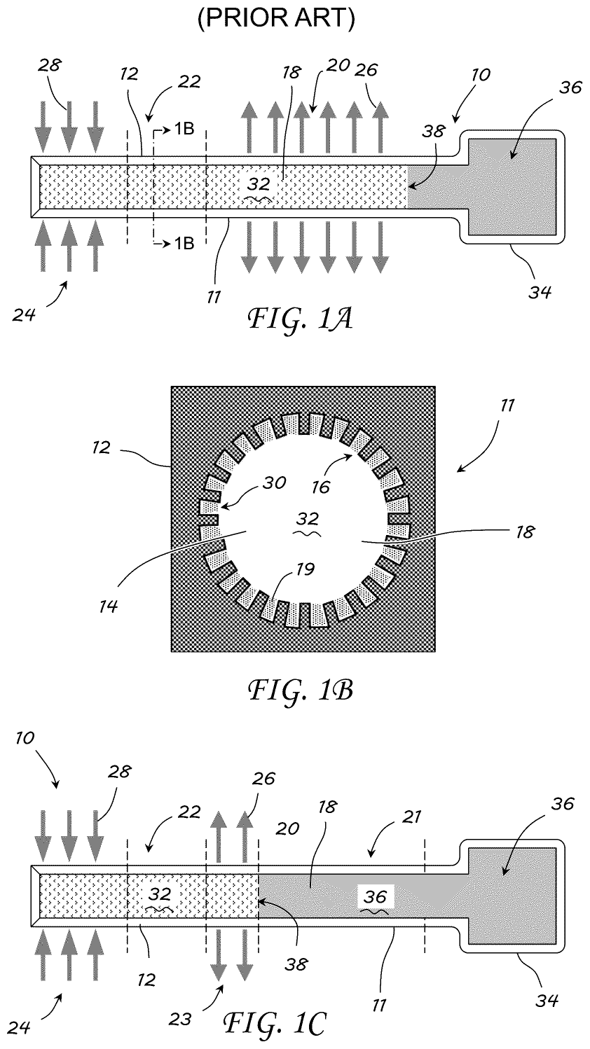

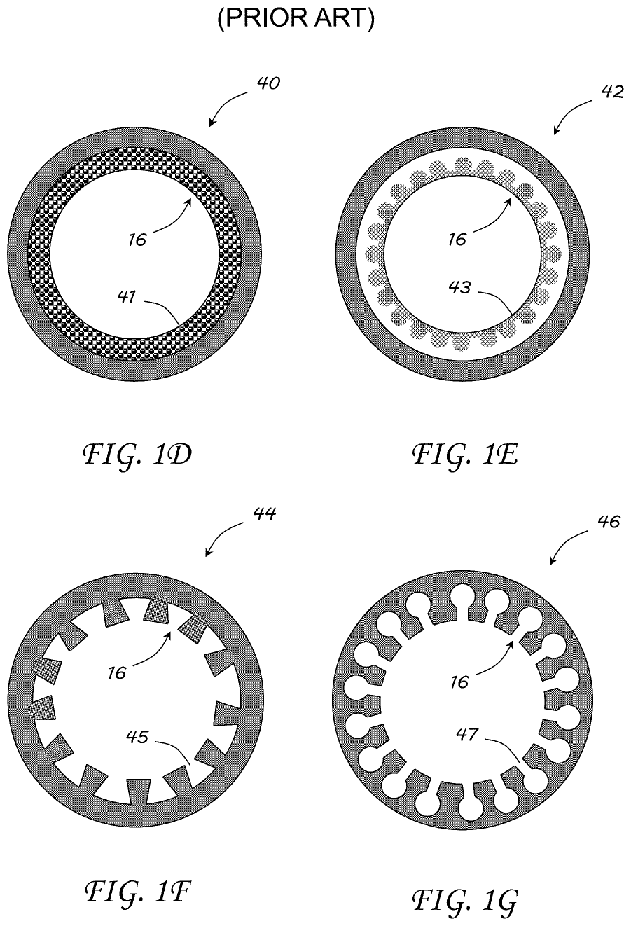

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments that can use heat pipes.

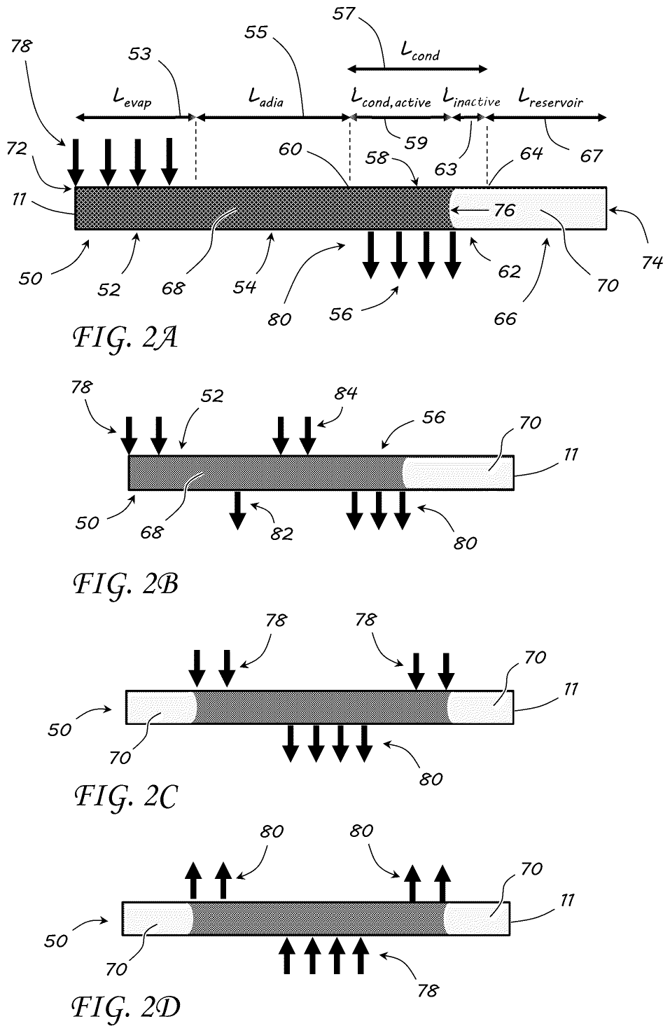

One embodiment of a Thermomodulating heat pipe (TMHP) 50 is schematically illustrated in FIG. 2A in a prograde heat transfer mode, i.e., the nominal design parameters, with relative section lengths. The TMHP 50 combines the hot-side Heat Regulation of a DHP and the cold-side Heat Regulation of a VCHP, eliminating the mass and temperature drop if mounting separate DHPs and VCHPs to each other. The TMHP 50 can be formed from a heat pipe envelope 11 suitable for use as a constant conductance heat pipe (CCHP) including a capillary wick and a vapor space interior of the capillary wick as previously discussed with respect to CCHP's and VCHP's, the internal details of which are not shown in the schematic illustrations which are intended to show relative sections in different operating modes. The capillary wick extends substantially continuously the full length of the TMHP 50. The TMHP includes, beginning at a first end 72 of the TMHP, a nominal evaporator section 52 having an evaporator length 53, an optional adiabatic section 54 having an adiabatic length 55, a nominal condenser section 56 having a condenser length 57 with an active condenser portion 58 beginning at a first end 60 of the nominal condenser section 56 closer to the nominal evaporator section 52, with an active condenser portion length 59 the active condenser portion extending to an inactive condenser portion 62 ending at a second end 64 of the nominal condenser section 56 away from the nominal evaporator section, having an inactive condenser portion length 63. A reservoir section 66 begins at the second end 64 of the nominal condenser section 56 and extends to a second end 74 of the TMHP 50, providing a reservoir length 67. The TMHP 50 contains a heat pipe fluid having a liquid phase and a vapor phase, with the capillary wick containing the liquid heat pipe fluid (not shown) as previously discussed with respect to CCHP's and VCHP's, with heat pipe fluid vapor 68 filling the vapor space of the nominal evaporator section 52 and the active condenser portion 58 at the nominal condition shown in FIG. 2A. A non-condensable gas (NCG) 70 fills, at the nominal condition shown in FIG. 2A, the vapor space of the reservoir section 66 and the inactive condenser portion 62. A diffuse front 76 exists between the heat pipe fluid vapor 68 and the NCG 70. For purposes of design, the diffuse front 76 can be treated as a flat front, while recognizing the reality that there is some amount of diffusion of the fluid vapor 68 and NCG 70.

Design of a TMHP can be adjusted to meet the needs of a given application with inputs considering the control dT, dT between hot and cold states, hot state conductance, and cold state temperature. Generally, a reservoir length 67 about one times the condenser length 63 is desirable, while a greater reservoir length 67 such as from about two to about three times the condenser length 63 would be useful in other embodiments, longer if needed. An evaporator length 53 should generally be less than or equal to the reservoir length 67 to ensure full switch off in a hot environment. Depending on how hot the environment, the evaporator length 53 may need to be shorter than the reservoir length 67 by some percentage. The evaporator and condenser lengths 53, 57 are not restricted relative to one another, but only relative to the reservoir length 67. In most applications, the reservoir length 67 will be longer than the condenser length 57 and in such situations the evaporator length 53 can be longer than the condenser length 57. There is no requirement for an adiabatic section 54 or adiabatic length 55. Most uses of TMHP currently contemplated are as a connecting heat pipe (similar to use of DHP), as such evaporators and condensers tend to be short. The total length of a TMHP may be limited by capillary transport limit, though as most applications anticipated require only short heat pipes and thus will not typically be a limiting factor. In the embodiment of FIG. 2A, the TMHP has heat received 78 through the nominal evaporator section 52 and heat rejected 80 through the active condenser portion 56.

An advantage of a TMHP is it can be flexible, like a CCHP, in that heat input and output can be variable along the length of the TMHP with multiple heat inputs and heat outputs, provided that there is always a net flow of heat from the nominal evaporator to a nominal condenser, as illustrated in FIG. 2B, showing heat received 78 through a nominal evaporator section 52 and a heat rejected 80 through a nominal condenser section 56 with an additional area with heat rejected 82 and an additional area with heat received 84 intermediate the nominal evaporator section 52 and nominal condenser section 56. However, a split heat flow could split the NCG 70 bubble as shown as shown in FIG. 2C and FIG. 2D, and the behavior would be outside of the TMHP design intent and outside of the requirements, thus a TMHP should not be used in these situations.

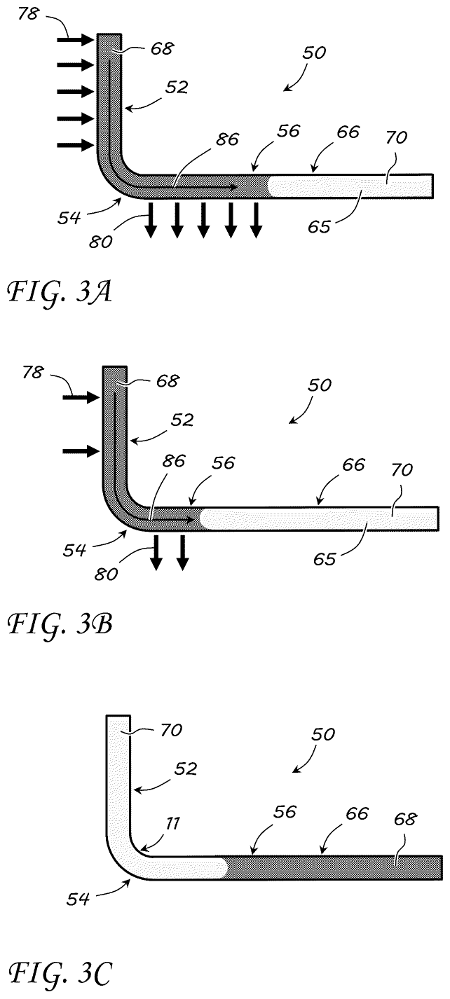

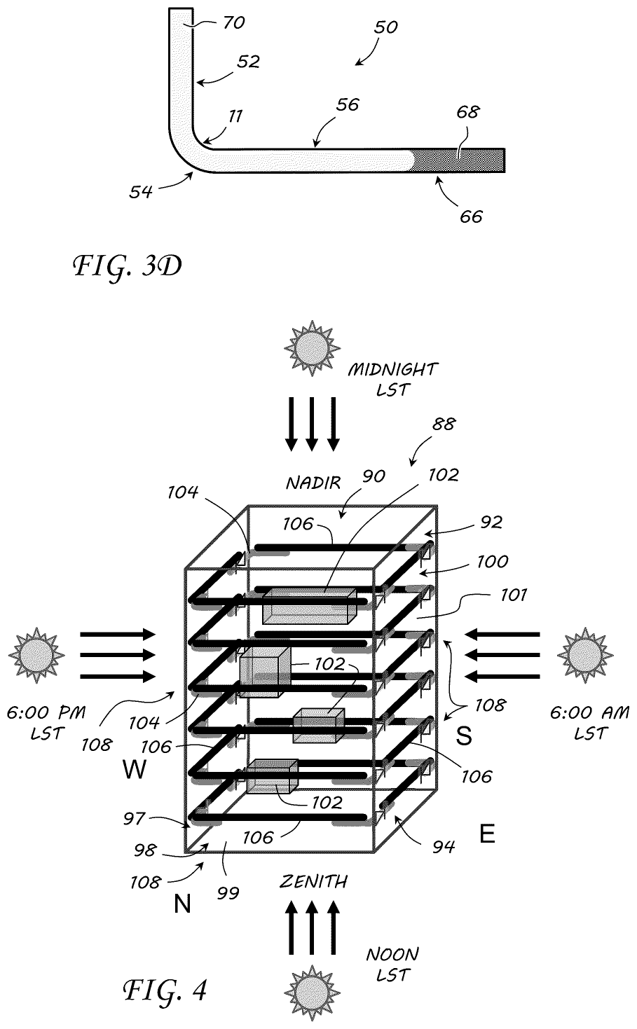

FIGS. 3A through 3D schematically illustrate TMHP 50 in various operating modes. TMHP 50 is illustrated as having an L shape, which can be very useful for satellite operation enabling heat transfer from one area to another. TMHP 50 provides a thermomodulating capability as thermal conductance passively varies to moderate payload temperature, while diodic in nature with heat transfer heavily preferred in a prograde direction 86. Designing a TMHP 50 can be simple as the same materials and processes (M&P) can be used, for example, standard grooved constant conductance heat pipe (CCHP) envelope plus NCG injection, eliminating complicated M&P typical in existing VCHP's and DHP's. A gas reservoir 65 stores NCG 70 which provides capabilities for the NCG 70 to incrementally block the nominal condenser 56 with lower temperature during prograde heat transfer and for the NCG 70 to fully block the nominal evaporator 52 with retrograde heat transfer. For examples discussed with respect to and illustrated in FIGS. 3A-3D, the temperatures used assume a gas reservoir length one times the length of the nominal condenser section. Longer gas reservoirs could enable higher hot state conductance, tighter control or lower hot operating temperatures, and considerations of TMHP design and gas reservoir lengths are provided later in this specification. FIG. 3A illustrates TMHP 50 in a prograde heat transfer mode at high temperature, such as with the nominal evaporator section at about 60 C and the nominal condenser section 56 at about 55 C. Heat received 78 flows into nominal evaporator section 52 and is transferred in a prograde direction 86 through the adiabatic section 54 to the nominal condenser section 56 with heat rejected 80 and with essentially all NCG 70 in the gas reservoir section 66. In another example, FIG. 3B illustrates TMHP 50 in a prograde heat transfer mode at low temperature, such as with the nominal evaporator section at about 10 C and the nominal condenser section 56 at about −20 C. Heat received 78 in nominal evaporator section 52 transfers in a prograde direction 86 through the adiabatic section 54 to the nominal condenser section 56 with heat rejected 80, and due to the lower temperature NCG 70 fills reservoir section 66 and blocks part of the nominal condenser section 56. In another example, FIG. 3C illustrates TMHP 50 in a retrograde heat transfer mode at high temperature, such as with the nominal evaporator section at about 60 C and the nominal condenser section 56 at about 100 C. Due to the higher temperature in the nominal condenser section, all the NCG 70 moves to the nominal evaporator section 52 and blocks the evaporator and adiabatic section 54, with parasitic levels of back conduction through the heat pipe envelope 11. In another example, FIG. 3D illustrates TMHP 50 in a retrograde heat transfer mode at low temperature, such as with the nominal evaporator section at about 10 C and the nominal condenser section 56 at about 20 C. Again, due to the higher temperature in the nominal condenser section, all the NCG 70 moves to the nominal evaporator section 52 and blocks the evaporator and adiabatic section 54, with parasitic levels of back conduction through the heat pipe envelope 11, while at the lower temperature than in the example of FIG. 3C, the NCG plug grows into and blocks a portion of the nominal condenser section 56.

As previously discussed, a TMHP 50 can use a conventional heat pipe envelope 11, such as a grooved extrusion, as the reservoir. Using a conventional heat pipe envelope enables a low volume reservoir eliminating the need for a reservoir bottle, reservoir screen wick, fluidic connection between a reservoir wick and an extrusion wick, and hermetic weld between the reservoir bottle and the heat pipe envelope. In this case, ‘low volume reservoir’ means that the reservoir's volume (i.e. length) is no more than a few multiples of the length of the condenser and possibly even shorter than the condenser. A TMHP 50 can use a cold gas wicked reservoir that does not need any heater feedback control. These design features can be implemented in the simplest possible way: by mounting the reservoir section of the heat pipe extrusion directly to the heat sink in the same manner (and indeed, even using the same mounting flange) as the condenser. Although cold gas wicked reservoir designs without heater feedback control have been used in the past, they are rarely used today because of the market's excessive focus on high precision payload Heat Regulation problems while ignoring market opportunities to solve unserved low precision bus Heat Regulation problems. Thus embodiments described teach against common VCHP practice.

In one embodiment brass can be used as the heat pipe envelope material and methanol as the heat pipe fluid of the TMHP 50. In another embodiment, stainless steel can be used as the heat pipe envelope material with methanol as well, although this is a well-known combination for VCHPs. Brass-methanol is known for CCHP applications. Determining a heat pipe fluid—heat pipe envelope material combination includes considering the fluid—material compatibility,

Several applications for the TMHP to meet unserved needs in spacecraft heat regulation have been identified.

FIG. 4 is a schematic depiction of a geosynchronous (GEO) satellite 88, such as a GEO communications satellite (CommSats) using TMHP's 50. The sun track on a geosynchronous satellite over a 24 hour orbit has high sun angles on the Nadir face 90, East face 92, Zenith face 94, and West face 96; with the North face 98 and South face 100 never seeing more than 23.5 degrees sun angle. A payload 102 such as an electronics unit that generates heat which needs to be dissipated is conventionally mounted on a satellite away from the four faces that can see normal sun and are thermally connected to a radiator, such as the North face 98 and/or the South face 100 which thus provide a North radiator 99 and South Radiator 101 as radiating panels. While the Nadir face 90 is typically reserved for antennas and the Zenith face 94 is typically reserved for propulsion equipment, either the East face 92 or the West face 96 is always out of the sun and can effectively provide a third useful radiating panel with the use of TMHPs. TMHPs allow this prospectively available surface area to offer opportunities for a 30-55% increase in heat rejection capacity, permitting bigger missions to be done with smaller spacecraft. As illustrated in FIG. 4, North radiator 99 and South radiator 101 each include multiple heat pipes 106, such as CCHP's, forming a heat pipe network 108 in each radiator that transports heat to and within the radiator. As the East face 92 and West face 96 can serve as radiators when out of the sun, multiple heat pipes 106 are also included forming heat pipe networks 108 in East radiator 93 and West radiator 97. L-shaped TMHPs 104 are mounted such that the nominal evaporator of each is mounted to the North radiator 99 or South radiator 101 and thermally connected to each radiator's heat pipe network 108, and the nominal condenser of each is mounted to either the East radiator 93 or the West radiator 97. When the East radiator 93 or West radiator 97 has a thermal environment colder than the L-shaped TMHP 104 nominal evaporator, the TMHP 104 allows a moderated heat transfer to the respective East radiator 94 or West radiator 97. When the East radiator 94 or West radiator 97 has a thermal environment hotter than the TMHP 104 nominal evaporator, the TMHP 104 shuts down and heat that would have otherwise gone through that TMHP 104 instead goes through another TMHP 104 serving the oppositely facing radiator. Several mostly unsuccessful attempts at recruiting East and West panels as radiators have been previously attempted, including: dual condenser loop heat pipes and high temperature heat pipes (HTHPs) such as Al-toluene heat pipes which can operate up to 150 C to provide cooling to electronics that can handle such temperatures. However, DCLHPs have the issues mentioned previously and HTHPs are only useful to cool a very limited set of electronics that can handle high operating temperatures, this in combination with the small gap between the maximum allowable electronics temperature and the hottest radiation environment make HTHP radiators on E/W faces quite ineffective. Use of TMHP to enable radiators on the East and West faces provides similar thermal value proposition to sun-nadir steering without complicated steering. Since East and West radiators only operate under no or minimal sun, they're solar absorptivity is less important. Traditional vent paths of east and West sides are still useful. While conventionally painted white, East and West radiators painted black they provide more consistent and predictable temperatures throughout life, reduce heater demand, reduce astronomical interference, all for minimal reduction in heat rejection capacity, though there would be a need to ensure that East/West panels can accept greater than 140 degrees C. Insulation, such as MLI blankets on the inside of East/West panels as well as Nadir and Zenith faces, can prevent hot East/West panels from radiating into the rest of the spacecraft. While this embodiment did not use the Nadir and Zenith faces, an atypical spacecraft not requiring use of these faces for other purposes could also use these faces as radiators.

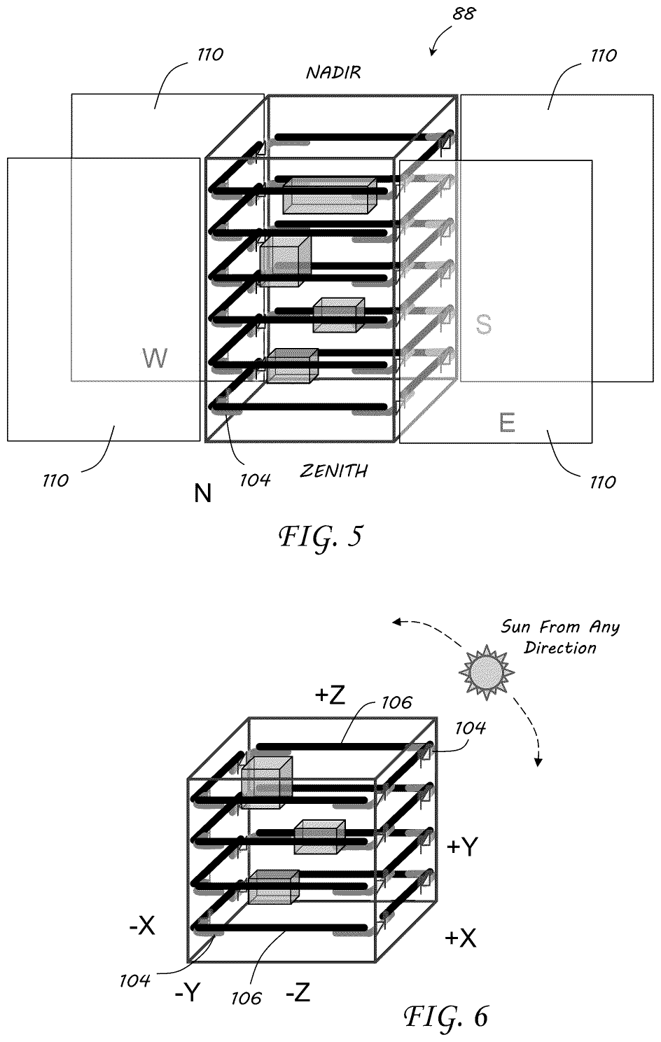

FIG. 5 is a schematic depiction of a geosynchronous satellite 88 also including deployable radiator panels (DRPs) 110 and using TMHP's 104. It is anticipated a 10% to 18% increase in heat rejection capacity for a 4 panel DRP spacecraft with no added heater demand.

FIG. 6 is a schematic depiction of a satellite using TMHP's to enable pointing to targets other than Nadir. Such target-pointed spacecraft point to targets using orthogonal steering laws (e.g. sun-target steering) which often expose thermal radiators to transient near-normal solar loads throughout the orbit. Such spacecraft types include: Astronomical satellites, Relay satellites (TDRS), Earth Observation satellites, Non-GEO weather satellites, and Space probes. The most general type of pointing constraint for such satellites is that they may point in any direction, subject to time duration constraints driven by Power and Thermal subsystems. Thermal radiators on up to 4 faces are feasible provided short (=low altitude) orbits, cross-coupling among radiators, and sufficient thermal mass. Thermal mass such as Beryllium or phase change materials (PCM) may be used to extend time frames. L-shaped TMHPs 104 could eliminate time constraints and permit freer pointing with smaller spacecraft and/or higher orbits. The proposed improved freely-pointed architecture is similar to proposed GEO commsat architecture illustrated in FIG. 4, wherein TMHPs 104 permit heat flow from +/−Y to +/−X radiators. For target-pointed spacecraft that do not already recruit E/W faces as radiators, TMHPs also offer 30-55% increase in heat rejection capacity.

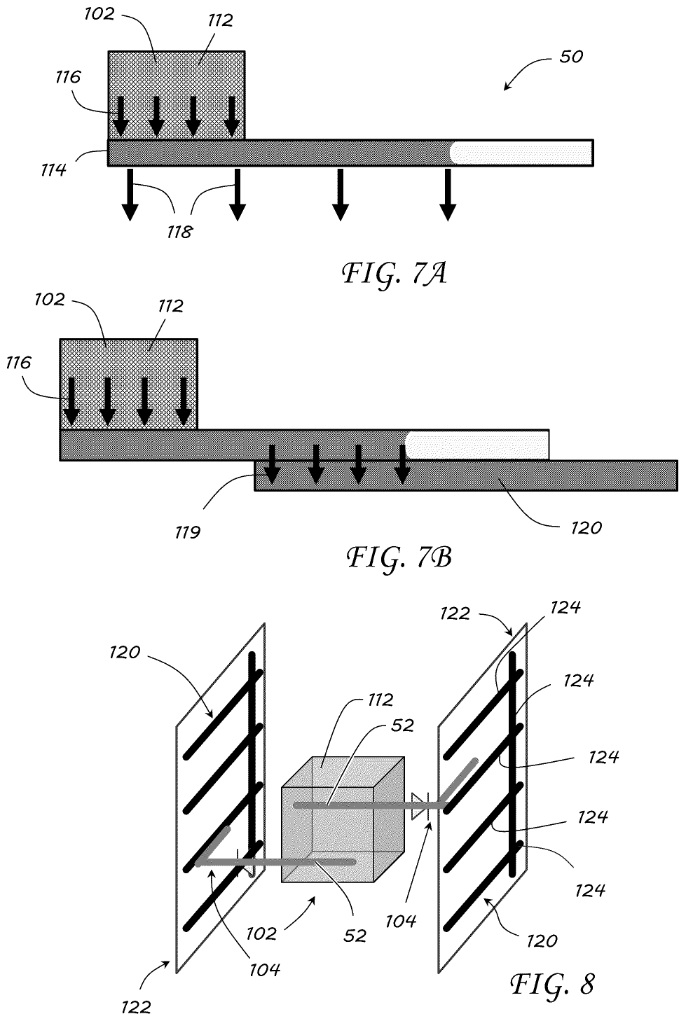

The embodiments discussed with FIGS. 4-6 generally assumed that electronics units are not mounted on radiator surfaces that can see normal sun, however TMHPs can also be used to permit mounting of electronics units on sun-normal radiators. FIG. 7. A illustrates a payload 102 such as an electronics unit 112 mounted on radiator panel 114 with an embedded TMHP 50 such that the electronics unit 112 rejects heat 116 to the TMHP evaporator and the TMHP 50 in turn radiates heat 118 to space. The electronics unit 112 could also be mounted to TMHPs' nominal evaporator. Whether mounted directly to the TMHP or to a radiator with an embedded TMHP, the rest of the TMHP beyond the nominal evaporator can extend into the thermal radiator or to a heat pipe network 120 as illustrated in FIG. 7B, such that heat 119 is conducted to other heat pipes in the heat pipe network 120. TMHP thus enables isolation of the electronics from the heat pipe network and most of the radiator (except for direct conduction from the unit to the radiator and within the radiator). The embodiments of FIGS. 7 A and 7B provide thermomodulation in both hot and cold environments. This can enable an estimated 30% heater power savings and reduce pointing constraints.

‘Some Space Probes encounter extreme thermal environments, including very hot transient environments which necessitate multiple counter-facing radiators, as illustrated in FIG. 8. A TMHP provides an all-in-one solution that Clementine achieved only with multiple separate heat pipes. This enables a cheaper, lighter, quicker, more reliable solution than most heritage space probe thermal control subsystems. As depicted in FIG. 8, payload 102, such as electronics unit 112, thermally coupled to nominal evaporator sections 52 of L-shaped ‘TMHP's 104 which in turn have their nominal condenser sections 56 thermally coupled to counter-facing radiators 122. Each counter-facing radiator 122 includes a heat pipe network 120, such as a network of constant conductance heat pipes 124 to transport heat within the radiator 122.

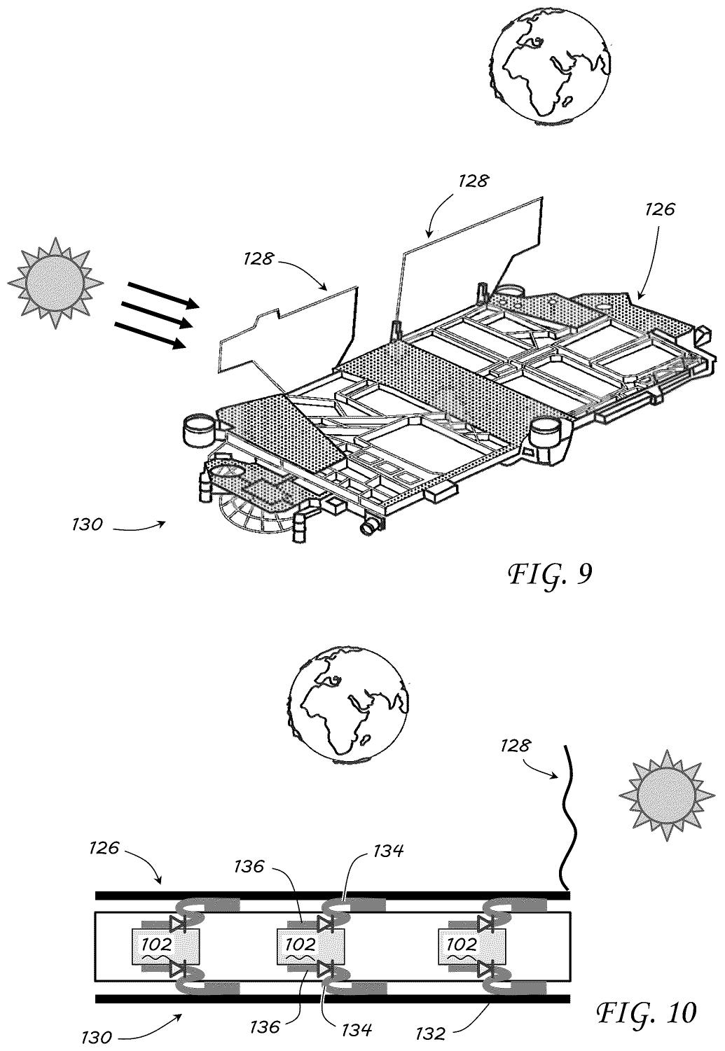

Reduced visibility proliferated LEO constellations (pLEO) are causing much trouble to astronomy. As illustrated in FIG. 9, one approach to reduce ground visibility includes making thermal radiators 126 black as well as using deployable visors 128 to block reflection from the sun, off of the satellite 130, to the earth. However, both black radiators 126 and visors 128 will tend to cause the spacecraft to overheat, reducing its lifetime. FIG. 10 illustrates a schematic depiction of a satellite 130 having a Zenith radiator 132 enabled by TMHPs 134 thermally coupled between a radiator 132 and a payload 102 electronics unit. In this embodiment, TMHP's 134 can permit two counter-facing (nadir and zenith) radiators to be used, both of which can be black and/or visored. A conventional heat pipe such as a GRDHP 136 can also be thermally coupled to the payload 102 intermediate the thermal coupling to the TMHP 134. This enables reduced astronomical interference, acceptable operating temperatures, up to an 80% increase in heat rejection capacity, and elimination of heater demand. Use of TMHPs 134 as shown could enable both the Nadir and Zenith facing surfaces to act as radiators that could be either black or white.

TMHP enables formerly thermally-useless panels to be recruited as thermal radiator panels. Many types spacecraft could benefit from TMHP's advantages which include: increased heat rejection capacity, decreased heater power demand, elimination of pointing constraints, enhanced reliability, elimination of complicated feedback mechanisms, lower costs, less mass, less volume, and easier installation.

In one embodiment a grooved wick heat pipe is extruded from a die, filled with both a heat pipe fluid and an NCG. As previously discussed, a TMHP has four nominal sections. “Nominal” indicates the designed-for thermophysical behavior of that section under prograde heat flow, i.e. the object-to-be-cooled (henceforth, ‘payload’) is warmer than the environmental sink temperature). The first section is the nominal evaporator, which receives heat through the envelope wall and uses it to evaporate liquid in the wick. The second section is the nominal adiabatic section in which heat neither enters nor leaves the heat pipe, in normal operation fluid travels through nominal adiabatic section without changing phase. The adiabatic section is optional. The third section is the nominal condenser, in which heat pipe vapor condenses, is collected by the wick and is transported back through the wick to the nominal evaporator by capillary tension. All of the operation of the heat pipe to this point is identical to the normal operation of the simplest heat pipe: a CCHP. The TMHP however, has a few additional features and capabilities. The nominal condenser is subdivided into two subsections: the active and inactive nominal condenser sections. The active section is where condensation can take place, the inactive section is blocked by NCG that has grown out from its location in the reservoir (the fourth section). The inactive section consumes more of the overall nominal condenser section at cold operating temperatures and less at high operating temperatures. At an initial, nominal condition, the NCG forms a diffuse front with the heat pipe fluid vapor, but does not change the physics of operation nor the first-order assessment of design concepts. The fourth section, as mentioned, is the reservoir section. Typical existing VCHPs use bottles of larger diameter than the heat pipe extrusion to achieve large reservoir volume to condenser volume ratios which gives high levels of control that are unnecessary to solve bus application Heat Regulation tasks, as earlier described. For simplicity and reliability, an embodiment of the TMHP uses the exact same extrusion, unmodified to serve as the reservoir section. This permits the simplest possible manufacturing approach.

Envelope material is selected based upon several criteria: fluid-envelope chemical compatibility, low thermal conductivity to minimize parasitic back conduction in hot environments, CTE-matched (coefficient of thermal expansion) to Al heat pipes preferred (23 ppm/C), high strength and stiffness to permit thin walls to reduce back conduction and mass, high formability, low density envelope preferred but not required as this is not strongly leveraged since heat pipe extrusions can be made quite thin and the TMHP is generally a short heat pipe. Heat pipe fluid is selected base upon several criteria: high capillary figure of merit (FOM) fluid preferred (not critical since the application uses short pipes), high gas control sensitivity factor (which determines how well the fluid responds to changes in temperature, providing more control), low vapor pressure to permit thinner envelope walls which reduces back conduction and mass.

An exemplary embodiment may have an envelope-fluid pair of CRES316-MeOH (Methanol). This pair has known compatibility, MeOH has great capillary FOM in a useful T range, MeOH has good gas sensitivity factor, MeOH has lower vapor pressure than the main incumbent for spacecraft heat pipes (ammonia). CRES has low thermal conductivity (−15 W/m/K), CRES316 is not quite CTE-matched (16 ppm/C) to Al, CRES316 density is 8 kg/m3 (rather high, but not critical), CRES is a very strong and stiff material with acceptable formability. CRES-MeOH is a popular combination for VCHPs. If CRES cannot be extruded in a grooved shape due to formability issues, a screen wick can be used instead of a grooved wick.

In situations where the CTE mismatch between CRES and Al is too great, a Brass-MeOH combination can be used. Brass (C36000 alloy) has a much closer CTE to Al (21 ppm/C), the pair has known compatibility, and the density is about the same as CRES (8.5 kg/m3). One downside is that Brass has a rather high thermal conductivity of 115 W/m/K. A Brass-MeOH TMHP may require extra length in the adiabatic section to provide thermal isolation. Brass-MeOH is not a common combination but Brennan and Kroliczek cite such a heat pipe having 800+ successful hours of operation. As with CRES, if brass cannot be extruded with a grooved wick, a screen wick can also be accommodated.

In cases where low density is prized (i.e. when a heat pipe needs to be long, for example if strain relief bends are required or if a long condenser and/or reservoir is required), Al can fit the bill. It also has a perfect CTE match to the other Al structure to which it is attached. Al, however does have a high thermal conductivity, which will likely necessitate a longer TMHP to achieve good resistance to back conduction. Ammonia is a good partner with Al, this combination is the most popular combination for all spacecraft heat pipes and is the most commonly used envelope-fluid pair for all types of spacecraft heat pipes. Al is also easy to form.

Other fluids or envelope materials can be used without departing from the intent and scope of the above examples.

A preferred TMHP wick embodiment is a grooved wick that is extruded as part of the envelope extrusion. Grooved wicks are generally preferred for spacecraft heat pipes because of their manufacturing simplicity, tendency not to generate unintended non-condensible gas, and high permeability which enables good heat transport over distances as long as 10 feet. One downside of grooved wicks is that their large capillary dimension gives them limited static wicking height (less than 1″ with typical fluids, grooved wick designs, and operating temperatures), however the large capillary dimension also gives high permeability so a grooved wick allows the best optimization for a microgravity environment. A wide variety of groove shapes have been designed for grooved heat pipes. These groove shapes tend to be measured on a spectrum that ranges from simple designs that are easily extruded, have comparatively lower heat transport capacity, reliable operation, and have heat transport capacity that is unaffected by the change in liquid density that happens over the operational temperature range. On the other end of the spectrum are more complicated designs that are less easily extruded, have substantially more heat transport capacity, in extreme cases are unreliable in operation, and have heat transport capacity that is affected by the change in liquid density over the operational temperature range. In the middle there is a happy medium of grooves with a somewhat easily extruded cross-section, good heat transport capacity, reliable operation, and manageable heat transport capacity effects caused by liquid density variation. Grooves at the simple end of the spectrum are rectangular grooves, the happy medium is trapezoidal grooves, somewhat more aggressive are arterial wick grooves, and overly complicated/non-workable are monogroove heat pipes. All of these grooves are acceptable, excepting monogroove heat pipes. Trapezoidal grooves are a preferred embodiment.

If a grooved wick cannot be extruded from the envelope material, a screen wick can also be used. A screen wick will tend to increase the cost of the heat pipe, may increase the development costs to prevent unintended gas generation, and will have less heat transport capacity in the space environment.

The TMHP can be either embedded in a honeycomb core panel or externally mounted to electronics units or other heat pipes or hardware. The nominal evaporator is thermally coupled to the payload via some combination of bolts, thermal interface materials, adhesive, epoxy, or other joining method. The nominal condenser and the reservoir are both attached to the heat sink via some combination of these techniques. The heat sink is another type of heat pipe, pumped fluid loop, thermal radiator, or other heat sink. The TMHP can use flanges (or not) to achieve these thermal interfaces. The reservoir does not have appreciable heat transfer through it so it does not require as good of thermal contact with the heat sink as does the condenser. Accordingly, savings opportunities should be taken advantage of, such as: having flanges only intermittently on the reservoir and/or using a thermal interface material from the reservoir to the heat sink that is lower performance and cheaper.

The TMHP can include strain relief bends between the nominal evaporator and the nominal condenser. Strain relief bends may be necessary in some cases to deal with thermal expansion mismatches between the TMHP and the panels it connects or embeds within. These expansion mismatches can occur because of temperature differentials between objects and are exacerbated if CTE mismatches are present. Strain relief bends will increase the length of the adiabatic section which enables increased thermal resistance to retrograde heat transfer (which may be useful if a high thermal conductivity envelope such as brass or Al is used) and also increases mass.

Simple CCHPs have a great deal of operational flexibility because evaporators and condensers can be interspersed along the heat pipe at arbitrary intervals and even changed real-time during operation. CCHPs' operational limits impose very little limitations on the locations of evaporators and condensers. This makes CCHPs extremely versatile: CCHPs can be used in a variety of ways with high robustness and little additional thought required from designers. For other types of heat pipes, operational constraints of this sort become more serious as the heat pipe becomes more complicated (and capabilities typically scale with complexity). The TMHP is a simpler form of heat pipe than typical VCHPs and DHPs, and far simpler than loop heat pipes (LHPs). A TMHP is arguably the second simplest type of heat pipe after CCHPs (with gas-charged heat pipes possibly tied with TMHP for second place). A gas-charged heat pipe is essentially a CCHP with an intentional gas charge to aid in smooth freeze/thaw operations.

Due to the TMHPs' simplicity, it has an accordant level of operational flexibility. While heat inputs and heat outputs cannot be located entirely arbitrarily, as in CCHPs, there are relatively few restrictions. The general thermophysics is that in normal prograde operation, there should be a net heat flow from the nominal evaporator to the nominal condenser (or at a minimum, no heat flow in the reverse direction). This insures that the heat pipe fluid sweeps the gas into the gas reservoir. If this constraint is not maintained there are risks of operational instability—a situation in which the gas partially or entirely moves to the other end of the pipe. Such a situation would cause unintended and unexpected operational behavior including loss of thermal conductance at a time when that is unacceptable, increase in thermal conductance at a time is unacceptable, or random variations in thermal conductance that do not provide the design-intent modulation of heat pipe thermal conductance.

This constraint on operation is not too onerous—there is no constraint on the number or location of either condensers or evaporators and there is no constraint on time variation of the locations of these heat inputs and outputs. Thus, moderate care during the design process can insure that a TMHP has good operational behavior in all environments.

TMHPs have similar design characteristics and constraints in terms of dealing with both liquid slugs and unintended gas generation. First: liquid slugs. Liquids change density over temperature, typically getting less dense at higher temperatures. For a heat pipe with a fixed mass of liquid (the mass of vapor is negligible, this means that the liquid will take up more space as the temperature changes. For heat pipe designers, this creates a conundrum: the designed space for the liquid is the space within the grooves. This liquid space is a fixed volume no matter what temperature the heat pipe is operating at within the operating range. Thus, the heat pipe designer must select a ‘fill temperature’: the temperature at which the liquid space is nominally full. Below the fill temperature, the liquid space is underfilled and above the fill temperature the liquid space is overfull and liquid must spill out into the vapor space of the heat pipe. In this situation a ‘liquid slug’ develops which tends to accumulate at the cold end(s) of the heat pipe. The liquid slug effectively blocks normal heat pipe operation from occurring in the region where the liquid slug is located. Early in the history of heat pipe development, some variable conductance heat pipes were actually developed to use this behavior to achieve variable conductance. Note that all VCHPs in use today use the gas reservoir approach, as used here in the TMHP. On the other hand, in an underfill situation, the grooved space is not completely full. With more aggressive grooved wicks (arterial wick, and especially monogroove), an underfilled groove will experience a larger capillary dimension which reduces capillary pumping power which reduces the heat pipe's transport capacity at low operating temperatures. All of the behavior described here as typical for CCHPs is the same for the TMHP. TMHP designers should carefully select groove shape and fill temperature to balance the effects of lost heat transport capacity at low temperatures versus the liquid slug length at high temperatures. TMHP designs should incorporate length in the heat pipe at the end of the condenser to accommodate liquid slug length.

Unintended gas generation is the same in TMHPs as in CCHPs or VCHPs. Unintended gas generation occurs with small amounts of corrosion reactions, often due to impure heat pipe fluids during fill or improper cleaning of the heat pipe walls prior to fill. Unintended gas has the same effect as the designed NCG: it tends to block out the condenser at cold operating temperatures, it tends to gather at the condenser end of the heat pipe, and will move to whichever end of the heat pipe is the actual condenser. In fact, VCHPs were first invented when the desirable variable conductance behavior was observed in an accidentally gassy heat pipe. In the case of TMHP, unintended gas would tend to adjust the operating temperature of the TMHP to a lower setpoint for a given heat input and operating temperature, it would increase the pressure in the heat pipe, and it would decrease the thermal conductance for both prograde and retrograde heat transfer. Accordingly, normal heat pipe manufacturing processes should be followed to avoid generation of unintended gas.

NASA CR-2018, “Theory and Design of Variable Conductance Heat Pipes” by B. D. Marcus (1972) (hereinafter, “Marcus”) provides an introduction into VCHP design, the disclosure of which is incorporated herein by reference. The TMHP improves upon and differentiates from conventional VCHP by providing a design intent that the non-condensable gas in the reservoir at a nominal condition will move to block the nominal evaporator in situations where the environmental sink temperature is hotter than the object to which the heat pipe is providing cooling, such as depicted in FIGS. 3C and 3D. As such, VCHP design principles govern what TMHP design can achieve what performance. Marcus notes that different heat pipe fluids have different ‘gas sensitivity factors’ which dictate how much control authority a given heat pipe fluid can achieve within a given VCHP. Marcus only provides data for four fluids, but methanol is found to be several factors better in this regard than the more traditional ammonia. Marcus also provides simple equations that characterize the ratio of nominal condenser volume to reservoir volume that takes into account a variety of VCHP performance metrics. The equation for the simplest form of VCHP, a cold wicked gas reservoir with no heaters (this is descriptive of the TMHP design), is shown here:

$$\frac{{V}_{C}}{{V}_{R}} = [ \frac{{P}_{vamax} - {P}_{vsmax}}{{P}_{vamin} - {P}_{vsmin}} \cdot \frac{{T}_{smin}}{{T}_{smax}} - 1 ] \qquad ( 1 )$$

This equation, in concert with the properties of methanol, the preferred embodiment fluid, provides insight into the ways VCHP performance metrics can be traded against one another and reservoir size. As a baseline, consider a TMHP with a nominal evaporator temperature than can range from 10 to 60 C and a nominal condenser that ranges from −20 C to 55 C. Such a TMHP requires a reservoir volume that is 1× the volume of the condenser. Because the TMHP reservoir has the same cross-sectional area as the condenser, this means that the reservoir is the same length as the condenser. This is a reasonable amount of size and weight to request to afford the advantages the TMHP offers. This is particularly true in cases where the TMHP acts as a connecting heat pipe and the length of the condenser (as well as the evaporator and adiabatic section) can be rather short.

Operational temperature ranges need to be considered. Many high power electronics units can accept a 60 C hot operating temperature. Cold operating temperature limits for such electronics units vary from as low as −20 C to about 10 C, depending on the sensitivities of the electronics in the unit. Smaller thermal cycling temperature ranges yields more reliable spacecraft electronics. Normal thermal control designs for such electronics require electrical heater power plus feedback control to maintain this minimum operating temperature. The ability of this example TMHP to vary the connection between the electronics unit and the heat sink to allow the electronics to be 10 C while the heat sink is −20 C means that the setpoint of the heater on the thermal radiator can be adjusted from 10 C to −20 C. The fourth power nature of thermal radiation means that this is 35% heater power savings, while still maintaining the electronics unit at a minimum operating temperature of 10 C, providing good reliability. On the hot operational side, there is a SC temperature drop through the TMHP. In general, less temperature drop in this situation is better as it allows the thermal radiator to be hotter and thus more effective at radiating power to space, permitting a smaller radiator or more powerful electronics. A SC temperature drop is reasonable, though less temperature drop would be ideal. In a hot non-operational case, the environmental sink temperature can get as hot as 90 or 100 C if direct solar illumination is upon the thermal radiator. This operating temperature can be designed based upon the thermo-optical properties of the thermal radiator. A thermal radiator with halfway decent properties in normal sun and no internally generated heat can easily stay within a 90 to 100 C limit. A 90 or 100 C limit is proposed as this is the practical temperature exposure limits of Al—NH₃ heat pipes, which are likely to be in such a radiator and mounted to the TMHP. Al-toluene heat pipes can allow operation to around 180 C and could also be used, however toluene is a much poorer heat transfer fluid and most electronics units require operation substantially below 180 C, which makes switchable architectures, such as proposed here with TMHP, much preferred. In a situation where the nominal condenser is 100 C and the electronics units are substantially cooler, say 60 C as in the hot operational case, there is a retrograde heat transfer. In this situation, the gas switches to the other end of the pipe and blocks the nominal evaporator from receiving heat flow. Instead, the evaporated fluid must condense in the nominal adiabatic section and the heat from the heat pipe can only enter the electronics unit via conduction through the heat pipe envelope walls. As described earlier, this can be a negligible effect if the heat pipe envelope cross-sectional area is thin, the envelope material is low thermal conductivity, and/or if the gas blocks a substantially longer length than the nominal evaporator. As such, in the retrograde heat transfer arrangement, the gas bubble should be at least as long as the nominal evaporator, and possibly longer depending on the thermal isolation needs of a given spacecraft. Note that if a given TMHP is operating in retrograde heat transfer mode, the object that TMHP is intended to cool probably still needs cooling. In this case, a second TMHP serving another counter-facing radiator provides cooling. Thus, two radiators can trade off cooling responsibilities as they come in and out of solar illumination. In situations where neither radiator is in the sun (e.g. eclipse) then both TMHPs can provide cooling, each partially blocking the condenser to provide modulated thermal control.

It should be noted again here that the TMHP's control performance would not be acceptable for the typical market applications of most existing VCHPs. However, the key point is that the VCHP market has focused excessively on payload applications and missed the opportunity for bus applications. The majority of today's satellites could benefit from TMHPs whereas VCHPs are, have been, and will continue to be a niche application.

By varying the operational temperatures in equation (1), some principles for TMHP performance vs. complexity can be elucidated:
Better hot state conductance can be traded at the cost of wider temperature cycling range
Larger reservoir enables reduced temperature cycling range, but poorly leveraged
Larger reservoir also enables increased hot state conductance, but again poorly leveraged
Larger reservoir also enables decreased differential temperature between hot and cold states, but yet again poorly leveraged

TMHP takes advantage of simple bus requirements (loose control, wide dT between hot & cold states, moderate hot state conductance) to achieve simple design: design is essentially a gas-charged heat pipe, simpler than either a typical DHP or a typical VCHP. No heaters, no feedback loops, no new wicks, no bottles.

TMHP trades the exquisite control capabilities of traditional VCHPs in favor of a more resilient, more capable, cheaper design to serve a previously unserved market.

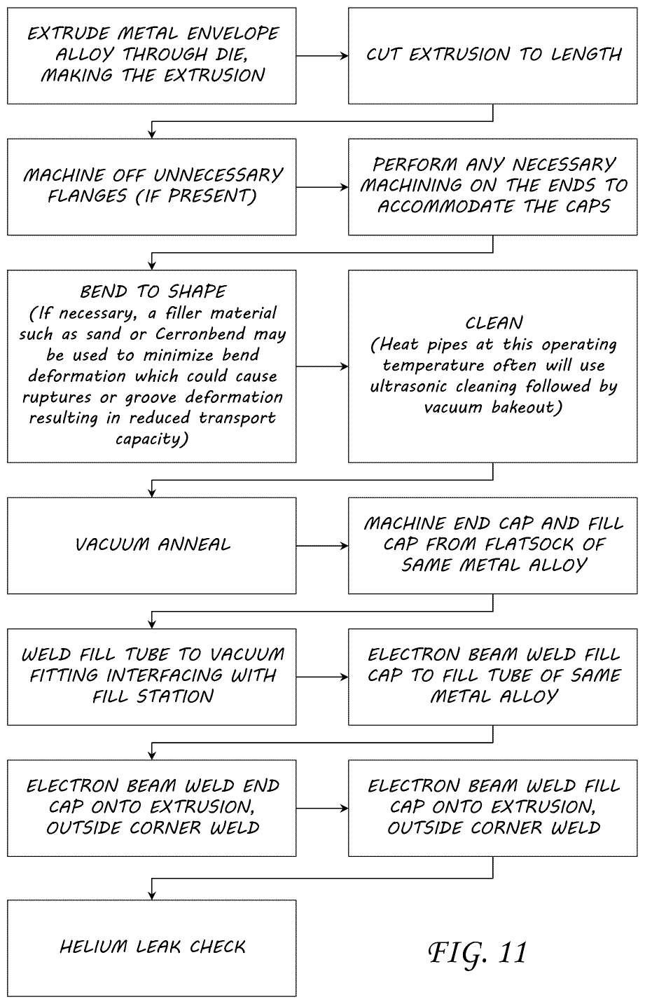

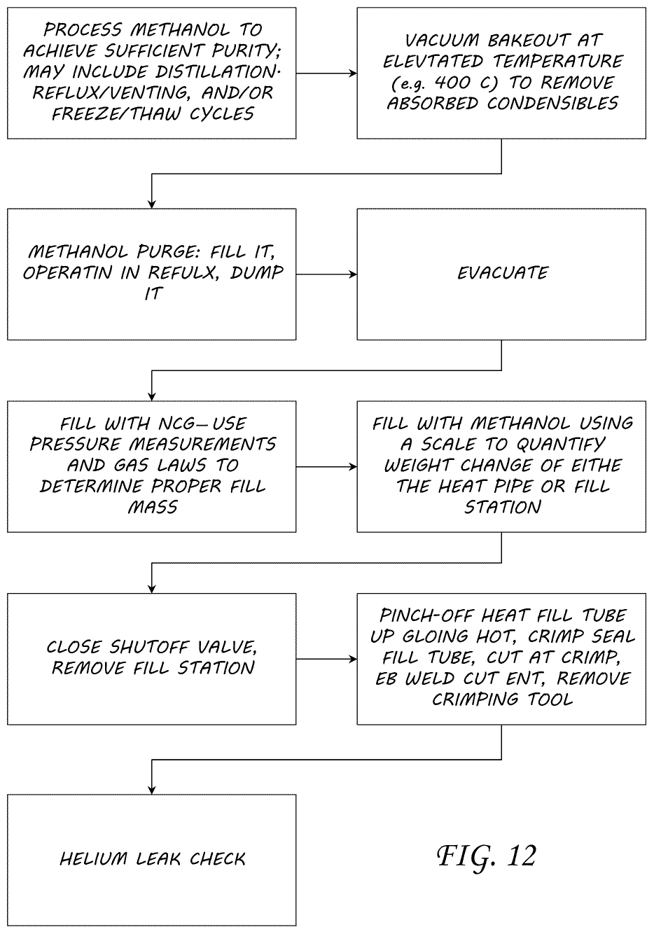

An example of the manufacturing process for a TMHP embodiment using a grooved wick is described below and outlined in FIG. 11, a flowchart of the Heat Pipe Envelope Manufacturing process, and FIG. 12, a flowchart of the TMHP Fill process. As described in these flowcharts, the TMHP manufacturing process closely follows the established processes for existing grooved wick constant conductance heat pipes (CCHPs).

With respect to the envelope manufacturing, the process shown in FIG. 11 is essentially the same as for a grooved wick CCHP. The TMHP fill process shown in FIG. 12 adds step 5 to the conventional process for filling with NCG using pressure measurements and gas laws to determine the proper fill mass, while a CCHP does not have any NCG. This additional step requires very little extra hardware and no additional set-up, making the TMHP eminently manufacturable. Note that in step 6, the methanol charge, like in other grooved wick heat pipes, should be enough to nominally fill the grooves at the temperature for which the heat pipe is nominally full (‘fill temperature’). Operation of the heat pipe below fill temperature can cause oscillatory behavior in heat pipes with more advanced wicks (especially arterial wick) and operation above fill temperature creates a liquid slug on the condenser side which can have deleterious effects if not designed-for.

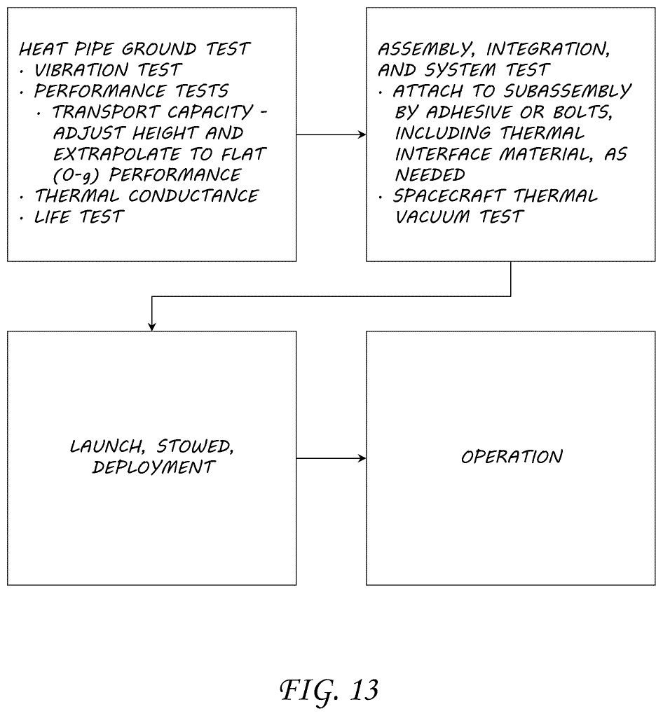

FIG. 13 provides a flowchart generally describing Test and Operation of a TMHP. A major difference from conventional CCHP is the added spacecraft thermal vacuum test. TMHPs should be operated with the entire TMHP in-plane with gravity. This means that the TMHP should be bent into a flat configuration (i.e. not a 3D heat pipe). Bottom-heated orientations may be operable in ground-testing (in which case the gas would float to the top) but thermal conductance will be different, variable conductance behavior will likely be different, and hot-environment shutdown will be impossible. Accordingly, a fully flat orientation is the only way to ground-test the TMHP to demonstrate all capabilities. The TMHP should be flat to within a small fraction of an inch. Note that CCHP testing is similar except that CCHPs can be bottom-heated and still validate their design. While there are no specific requirements differentiating a TMHP from a CCHP for the Launch, Stowed and Deployment, there should be similar or better robustness to spin rates and other body forces as typical CCHP. Operation should be as described for TMHP, without special requirements imposed on the rest of the aircraft, and 15+ year of unmaintained life is easily possible for properly cleaned and built TMHPs.

Heaters and feedback loops can provide additional control authority and other performance enhancements but this would likely come at a cost that would potentially price TMHPs out of their intended market. A hot unwicked reservoir could be used but that would require welding additional components into the TMHP and also likely become price prohibitive for the intended market. The cold wicked reservoir could be maintained but a bottle could be used which would permit marginally improved performance but, yet again, this would likely price TMHP out of the intended market.

TMHPs can be used with varying condenser, evaporator, adiabatic, and reservoir lengths to accommodate the various applications described

The embodiments described are intended for space applications, especially satellites and space probes. However, applications on human space missions are also possible. Human space missions require tighter temperature control, so more complicated VCHP features may be worthwhile. However, the ability to switch off thermal radiators is still attractive in human space missions as it simplifies thermal radiator design and permits smaller, lighter thermal radiators than existing radiators for human spaceflight.

While the present invention has been illustrated by a description of one or more embodiments thereof and while some of these embodiments have been described in detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A spacecraft system for heat regulation comprising:
a payload;
a radiator; and
a thermomodulating heat pipe (TMHP) adapted to transport heat between the payload and the radiator; wherein the TMHP further comprises:
a heat pipe envelope suitable for use as a constant conductance heat pipe (CCHP) including a capillary wick extending substantially continuously the full length of the TMHP, and a vapor space interior of the capillary wick; wherein the heat pipe envelope further comprises:
a nominal evaporator section;
a nominal condenser section, wherein the nominal condenser section comprises an active condenser portion beginning at a first end of the nominal condenser section closer to the nominal evaporator section and an inactive condenser portion ending at a second end of the nominal condenser section away from the nominal evaporator section; and
a reservoir section beginning at the second end of the nominal condenser section;
a heat pipe fluid having a liquid phase and a vapor phase, wherein the capillary wick contains liquid heat pipe fluid and, at a nominal condition, heat pipe fluid vapor fills the vapor space of the nominal evaporator section and the active condenser portion;
a non-condensable gas (NCG) filling, at the nominal condition, the vapor space of the reservoir section and the inactive condenser portion; and
wherein, at the nominal condition, the NCG forms a diffuse front with the heat pipe fluid vapor.

2. The spacecraft system of claim 1 wherein the heat pipe envelope further comprises an adiabatic section intermediate the nominal evaporator section and the active condenser section.

3. The spacecraft system of claim 1 wherein the capillary wick is selected from the group of a grooved wick, a screen wick, and a sintered metal wick.

4. The spacecraft system of claim 1 wherein the heat pipe envelope comprises an extruded bore.

5. The spacecraft system of claim 4 wherein the capillary wick has a grooved wick structure selected from the group consisting of a rectangular grooves, trapezoidal grooves, and arterial wick grooves.

6. The spacecraft system of claim 1 wherein the TMHP further comprises at least one strain relief bend between the nominal evaporator section and the nominal condenser.

7. The spacecraft system of claim 1 further comprising a second heat pipe thermally coupled to the radiator, wherein the TMHP is thermally coupled to the second heat pipe to transport heat to the radiator.

8. The spacecraft system of claim 1 further comprising a third heat pipe thermally coupled to the payload, wherein the TMHP is thermally coupled to the third heat pipe to receive heat from the payload.

9. The spacecraft of claim 1 wherein the spacecraft is designed for being one of a geosynchronous orbit spacecraft and a target-pointed spacecraft, and further wherein the spacecraft has an East facing side and a West facing side, the spacecraft having at least one TMHP installed on at least one of the East facing side and the West facing side.

10. A heat pipe comprising:
a heat pipe envelope suitable for use as a constant conductance heat pipe (CCHP) including a capillary wick extending substantially continuously the full length of the heat pipe, and a vapor space interior of the capillary wick; wherein the heat pipe envelope further comprises:
a nominal evaporator section;
a nominal condenser section, wherein the nominal condenser section comprises an active condenser portion beginning at a first end of the nominal condenser section closer to the nominal evaporator section and an inactive condenser portion ending at a second end of the nominal condenser section away from the nominal evaporator section; and
a reservoir section beginning at the second end of the nominal condenser section;
a heat pipe fluid having a liquid phase and a vapor phase, wherein the capillary wick contains liquid heat pipe fluid and, at a nominal condition, heat pipe fluid vapor fills the vapor space of the nominal evaporator and the active condenser portion;
a non-condensable gas (NCG) filling, at the nominal condition, the vapor space of the reservoir section and the inactive condenser portion; and
wherein, at the nominal condition, the NCG forms a diffuse front with the heat pipe fluid vapor.

11. The heat pipe of claim 10 wherein the heat pipe envelope further comprises an adiabatic section intermediate the nominal evaporator section and the active condenser section.

12. The heat pipe of claim 10 wherein the heat pipe envelope is formed from one of an aluminum, a stainless steel and a brass alloy material.

13. The heat pipe of claim 10 wherein the heat pipe fluid is selected from the group consisting of ammonia and methanol.

14. The heat pipe of claim 10 wherein the reservoir section has a vapor space volume between about 0.75 to 10 times a vapor space volume of the nominal condenser section.

15. The heat pipe of claim 14 wherein the reservoir section vapor space volume is between about 0.75 to 3 times the vapor space volume of the nominal condenser section.

16. The heat pipe of claim 10 wherein the heat pipe envelope comprises a material compatible with a heat pipe fluid selected from the combinations of CRES316 with Methanol; Brass and Methanol; and Aluminum and ammonia.

17. The heat pipe of claim 10 wherein the nominal condition of the heat pipe is prograde heat transfer with the nominal evaporator section at a higher temperature than the nominal condenser section, and further wherein in the event of the nominal condenser section becoming warmer than the nominal evaporator section, the NCG will diffuse through the heat pipe fluid vapor and move to the nominal evaporator section enabling a retrograde heat transfer.

18. A first thermomodulating heat pipe (TMHP) comprising the heat pipe of claim 10 wherein the reservoir section is thermally coupled to the nominal evaporator section of a second TMHP comprising a heat pipe of claim 9, and further wherein the nominal condenser section of the second TMHP is thermally coupled to the thermal radiator of the first TMHP.

19. The heat pipe of claim 10 wherein the reservoir further comprises at least one temperature sensor to provide feedback control as means to control the temperature of the reservoir section.

20. The heat pipe of claim 19 wherein the means to control the temperature of the reservoir section is selected from the group consisting of heaters, cold-biased radiators, and thermoelectric coolers.
